(19) United States
(12) Patent Application Publication
(10) Pub. No.: US 2008/0161045 A1
(43) Pub. Date: Jul. 3, 2008

(54) Method, Apparatus and Computer Program Product for Providing a Link to Contacts on the Idle Screen

(75) Inventor: Marika Vuorenmaa, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/618,127

(22) Filed: Dec. 29, 2006

(51) Int. Cl. H04M 1/00

(52) U.S. Cl. 455/556.1

(57) ABSTRACT

An apparatus for providing a link to contacts on an idle screen may include a processing element. The processing element may be configured to provide an identifier associated with a particular contact for display on an idle screen. In response to receipt of a selection of the identifier, the processing element may be further configured to provide at least one option for a communication related service associated with the identifier. In response to receipt of a selection of an option, the processing element may be further configured to launch an application corresponding to the selected option for executing the communication related service utilizing predefined information associated with the identifier.

### TECHNOLOGICAL FIELD

Embodiments of the present invention relate generally to mobile communication technology and, more particularly, relate to a method, apparatus and computer program product for providing a link to contacts on the idle screen.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase convenience to users relates to the delivery of services to a user of a mobile terminal. The services may be in the form of a particular media or communication application desired by the user, such as a music player, a game player, an electronic book, short messages, email, etc. The services may also be in the form of interactive applications in which the user may communicate with a network device in order to perform a task or achieve a goal. The services may be provided from a network server or other network device, or even from the mobile terminal such as, for example, a mobile telephone, a mobile television, a mobile gaming system, a mobile computer, etc.

Due to the ubiquitous nature of mobile communication devices, people of all ages and education levels are now utilizing mobile terminals to communicate with other individuals or contacts. Many users of mobile terminals typically have a smaller circle of contacts with which the majority of their communications are conducted. However, these contacts may be intermixed with less frequently used contacts in a comprehensive contact list, thereby making selection of the commonly used contacts more difficult. Additionally, some users may find it difficult to read text on a display of limited size.

With the increased efforts being made to provide ever more applications for mobile terminal users to utilize, some people may become overwhelmed by the user interface of the mobile terminal. For example, with regard to communicating with friends, co-workers, relatives, etc., there may be numerous communication modes which may be employed (e.g., short message service (SMS), multimedia messaging service (MMS), email, chat, push-to-talk, presence, calling, etc.), many of which are unfamiliar to a particular user. Furthermore, it is typical for each different communication mode to be associated with a different application that may be launched from a separate submenu within a main menu. Accordingly, to some users, the robust capability of a mobile terminal may be a hindrance, rather than a help since they are unable to effectively navigate the many menus provided.

Accordingly, it may be advantageous to provide an improved user interface, which may overcome at least some of the disadvantages described above.

### BRIEF SUMMARY

A method, apparatus and computer program product are therefore provided to enable improved user interface capabilities. In particular, a method, apparatus and computer program product are provided to enable, for example, a user to quickly access contacts by adding a visual link to such contacts on the idle screen display. In this regard, the idle screen or home screen may present a graphic, icon, photo or other identifier of a particular contact on the idle screen in order to provide a link to access functionality associated with contacting the particular contact. As such, the user may be enabled to select the particular contact without navigating numerous other menus. After selecting the particular contact, the user may be offered a set of options for contacting the particular contact based on the communication modes for which contact information is available for the particular contact. Thus, for example, from the idle screen, the user may easily select commonly used contacts and set up communication via a desired communication mode in a simple and efficient way. Additionally, the identifier which provides links to enable the features described above may be displayed on the idle screen in a fashion that can be tailored to user preferences. Accordingly, user experience may be enhanced and the user interface for electronic devices such as mobile terminals may be improved.

In one exemplary embodiment, a method of providing a link to contacts on the idle screen is provided. The method may include providing an identifier associated with a particular contact for display on an idle screen. The method may further include, in response to receipt of a selection of the identifier, providing at least one option for a communication related service associated with the identifier. The method may further include, in response to receipt of a selection of an option, launching an application corresponding to the selected option for executing the communication related service utilizing predefined information associated with the identifier.

In another exemplary embodiment, a computer program product for providing a link to contacts on the idle screen is provided. The computer program product includes at least one computer-readable storage medium having computer-readable program code portions stored therein. The computer-readable program code portions include first, second and third executable portions. The first executable portion is for providing an identifier associated with a particular contact for display on an idle screen. The second executable portion is for, in response to receipt of a selection of the identifier, providing at least one option for a communication related service associated with the identifier. The third executable portion is for, in response to receipt of a selection of an option, launching an application corresponding to the selected option for executing the communication related service utilizing predefined information associated with the identifier.

In another exemplary embodiment, an apparatus for providing a link to contacts on the idle screen is provided. The apparatus may include a processing element. The processing element may be configured to provide an identifier associated with a particular contact for display on an idle screen. In response to receipt of a selection of the identifier, the processing element may be further configured to provide at least one option for a communication related service associated with the identifier. In response to receipt of a selection of an option, the processing element may be further configured to launch an application corresponding to the selected option for executing the communication related service utilizing predefined information associated with the identifier.

In another exemplary embodiment, an apparatus for providing a link to contacts on the idle screen is provided. The apparatus may include means for providing an identifier associated with a particular contact for display on an idle screen, means for, in response to receipt of a selection of the identifier, providing at least one option for a communication related service associated with the identifier and means for, in response to receipt of a selection of an option, launching an application corresponding to the selected option for executing the communication related service utilizing predefined information associated with the identifier.

Embodiments of the invention may provide a method, apparatus and computer program product for employment in systems to enhance user experience during mobile communications. As a result, for example, users may benefit from using mobile terminals and other electronic devices with improved user interface capabilities.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing a visual link to contacts on the idle screen according to an exemplary embodiment of the present invention;

FIG. 4 illustrates an idle screen according to an exemplary embodiment of the present invention;

FIG. 5 illustrates a response of the idle screen to selection of a particular contact according to an exemplary embodiment of the present invention; and

FIG. 6 is a flowchart according to an exemplary method for providing a link to a contact on the idle screen according to another exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

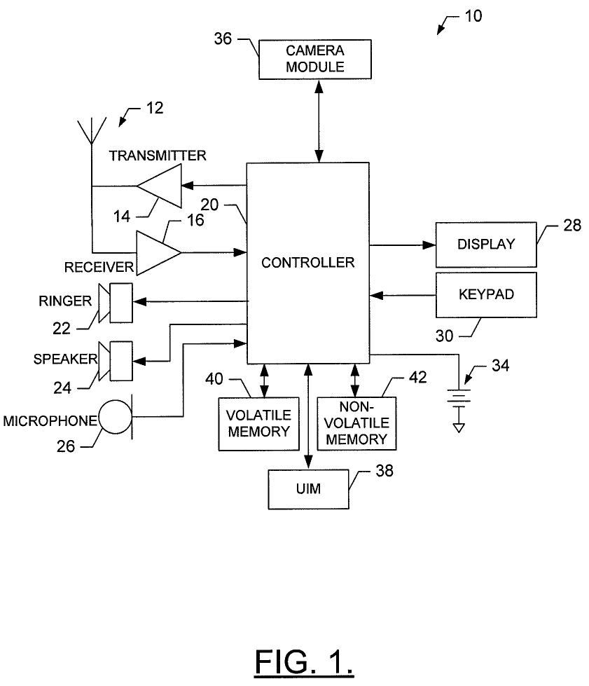

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

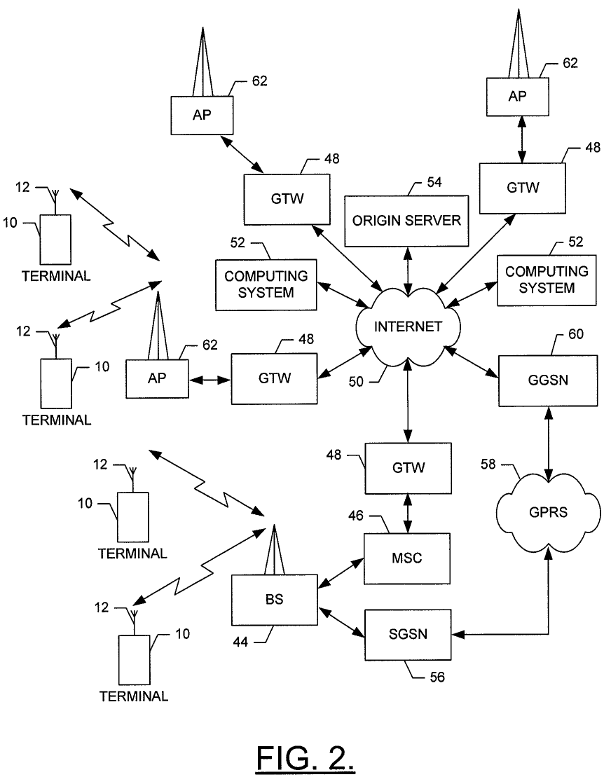

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1 and a network device of the system of FIG. 2 in order to execute applications for establishing communication between the mobile terminal 10 and other mobile terminals, for example, via the system of FIG. 2. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a network device or other device accessible to the communication device.

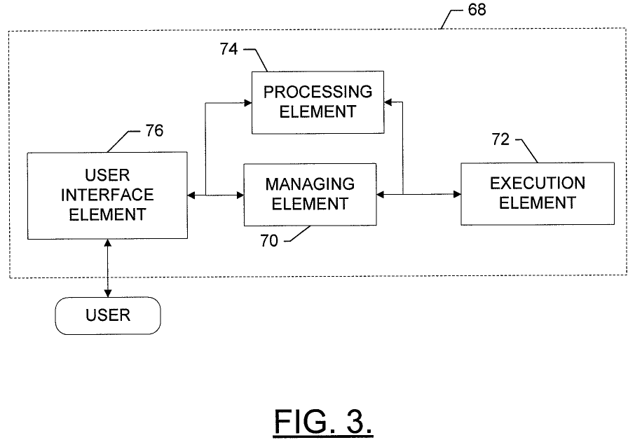

FIG. 3 illustrates a block diagram of a system for providing a visual link to contacts on the idle screen according to an exemplary embodiment of the present invention. The system of FIG. 3 will be described, for purposes of example, in connection with the mobile terminal 10 of FIG. 1. However, it should be noted that the system of FIG. 3, may also be employed in connection with a variety of other devices, both mobile and fixed, and therefore, embodiments of the present invention should not be limited to application on devices such as the mobile terminal 10 of FIG. 1. It should also be noted, that while FIG. 3 illustrates one example of a configuration of a system for providing a visual link to contacts on the idle screen, numerous other configurations may also be used to implement embodiments of the present invention.

Referring now to FIG. 3, an apparatus 68 for providing a visual link to contacts on the idle screen is provided. It should be noted that the apparatus 68 may be a functional apparatus which could be embodied in hardware, software, or a combination of hardware and software. In one embodiment, the apparatus 68 may be an application stored or otherwise accessible by a mobile terminal and executable, for example, by the controller 20 of FIG. 1. The apparatus 68 may include a managing element 70 and an execution element 72 each of which may be controlled by, or otherwise embodied in, a processing element 74. The apparatus 68 may also include a user interface element 76 which may be in communication with the managing element 70 and the execution element 72, for example, via the processing element 74. Processing elements as described herein may be embodied in many ways. For example, the processing element 74 may be embodied as a processor, a coprocessor, a controller or various other processing means or devices including integrated circuits such as, for example, an ASIC (application specific integrated circuit). In an exemplary embodiment, the processing element 74 could be the controller 20 of FIG. 1.

The managing element 70 and the execution element 72 may each be any device or means embodied in either hardware, software, or a combination of hardware and software that is capable of performing the corresponding functions of the managing element 70 and the execution element 72 as described in greater detail below. Specifically, the managing element 70 may be configured to provide functionality for creating, managing, editing, etc. links to a contact and/or a communication application on the idle screen. Meanwhile, the execution element 72 may be configured to provide execution of a communication application associated with a communication mode selected in association with a contact having its corresponding link selected from the idle screen.

The user interface element 76 may be any device or means embodied in either hardware, software, or a combination of hardware and software that is capable of receiving user inputs and/or providing an output to the user. The user interface element 76 may include, for example, a keyboard, keypad, function keys, mouse, scrolling device, touch screen, or any other mechanism by which a user may interface with the apparatus 68. The user interface element 76 may also include a display, speaker or other output mechanism for providing user output to the user. In an exemplary embodiment, rather than including a device for actually receiving the user input and/or providing the user output, the user interface element 76 could be in communication with a device for actually receiving the user input and/or providing the user output. As such, the user interface element 76 may be configured to receive indications of the user input from an input device and/or provide messages for communication to an output device.

In an exemplary embodiment, the user interface element 76 may be configured to receive user input and/or instructions with regard to establishment and maintenance of links on an idle screen or home screen (e.g., of the mobile terminal 10). The user interface element 76 may also receive data for presentation to the user from the managing element 70, the execution element 72 and/or the processing element 74.

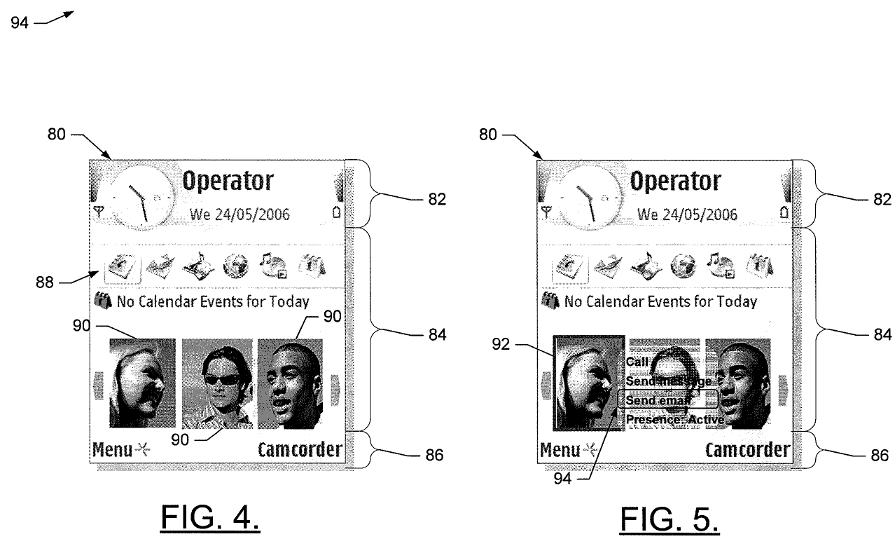

FIG. 4 illustrates an example of a user interface that may be displayed, for example, at a mobile terminal. In particular, FIG. 4 illustrates an idle screen 80 according to an exemplary embodiment of the present invention. The idle screen 80 may be, for example, the screen display/image that is presented when a device is in an idle state such as when the user has not interacted with the device for a period of time. As shown in FIG. 4, the user interface may correspond to a home screen display (e.g., the idle screen 80) and may include a plurality of regions or panes. The panes may include, for example, a status pane 82, a main pane 84, a control pane 86 and/or the like. The status pane 82 may include information elements such as a title, context, navigation information, signal strength indication, time, date, battery power indicator, etc. The control pane 86 may include, for example, a command button area and/or a menu bar for accessing a main menu or a particular submenu. The main pane 84 may include a menu bar 88 leading to submenus for selection of particular applications or functionalities which a device (e.g., the mobile terminal 10) employing embodiments of the present invention may be capable of executing. The main pane 84 may also include status messages related to events associated with the device. In an exemplary embodiment, the main pane 84 may also include one or more visual links or identifiers 90 which will be described in greater detail below. Each of the identifiers 90 may be associated with a particular contact and may link to functionality for accessing communication related operations related to the particular contact. In other words, each of the identifiers 90 may link to an application for accessing communication related operations with predefined information relating to the particular contact with which the link is associated. FIG. 5 illustrates a response of the idle screen 80 to selection of a particular contact according to an exemplary embodiment of the present invention. A contact may be, for example, a data record associated with a particular individual or other entity that generally includes contact information (e.g., phone number, fax number, email address, etc.) for enabling the establishment of communication with the particular individual or other entity.

It should be appreciated that although FIGS. 4 and 5 illustrate an exemplary idle screen, idle screens may have different configurations to those displayed in FIGS. 4 and 5. In particular, home screen or idle screen settings may be altered by the user, thereby changing the configuration of the idle screen 80. As such, FIGS. 4 and 5 are merely provided for purposes of example to aid in explanation of an exemplary embodiment, and are not provided for purposes of limitation. A user may provide inputs to the user interface element 76, for example, by making selections using fixed function keys associated with a keypad (e.g., of the mobile terminal 10) and/or by selecting items on the idle screen 80 (e.g., the identifiers 90, menu items, etc.).

As stated above, the managing element 70 may be configured to enable creation, management, editing, etc. of a link to a corresponding contact associated with each corresponding one of the identifiers 90. In this regard, the user may create a new identifier in numerous ways. For example, the user may be provided with an option to create an identifier, which may be referred to as a “hot buddy” link, for presentation on the idle screen 80 in response to creation, importation, download, etc. of an image, graphic, photo, icon, contact entry, etc. In one embodiment, after taking a photo or otherwise capturing an image with the camera module 36, the user may be prompted or otherwise have an available option with regard to creation of an identifier (e.g., a hot buddy link) by linking contact information to the photo. Alternatively, after creating, updating or otherwise accessing a contact entry for a contact list, the user may be prompted or otherwise have an available option with regard to creation of an identifier to be associated with the contact. As yet another example, in response to receiving a graphic, photo, etc. from a particular contact, the user may be prompted or otherwise have an available option for associating the graphic, photo, etc. with the particular contact by creating an identifier using the graphic, photo, etc., in association with the contact information for the particular contact. In an exemplary embodiment, upon selecting an option for creation of an identifier, the managing element 70 may request (or automatically gather) information from the user to be stored as predefined information in association with the identifier. The requested information may include a phone number, email address, and/or any other identification information which may be utilized for establishing communication with the contact associated with the identifier by a communication mechanism supported by, for example, the mobile terminal 10. Communication mechanisms or modes may include, for example, calling, chat, SMS, MMS, email, push-to-talk, presence, etc. In an exemplary embodiment in which the identifier is created directly from a contact entry, portions of the requested information which are already associated with the contact entry may be automatically associated with the identifier and stored as the predefined information. The predefined information may later be edited using the management element 76 in similar fashion to that described above.

The managing element 70 may include or otherwise be in communication with a storage device (e.g., the volatile memory 40 and/or the non-volatile memory 42) to enable storage of the predefined information associated with each of the identifiers 90. Accordingly, each identifier may be adapted to establish communication with the contact associated with the identifier by the specific mechanisms for which the predefined information for enabling such communication have been stored since, as stated above, the predefined information related to, for example, calling, chat, SMS, MMS, email, push-to-talk, presence, etc. may be stored in association with each particular identifier. In other words, the predefined information associated with each of the identifiers 90 may be tailored to each specific identifier. Thus, for example, if contact A has a known email address, in response to selection of the identifier associated with contact A, an option for emailing A may be presented. However, if contact A has no known email address, in response to selection of the identifier associated with contact A, no option for emailing may be presented.

The execution element 72 may be configured to execute links to applications and/or links to information utilized in the execution of applications for the establishment of communication with a contact associated with a particular identifier and/or for employment in connection with communication related services associated with the contact. In an exemplary embodiment, upon selection of a particular identifier, the execution element 72 may access the predefined information associated with the particular identifier and generate a function selection console 94 (see FIG. 5) providing the user with, for example, a menu or list of options with respect to the establishment of communication with the contact associated with the particular identifier and/or provision of communication related services associated with the particular identifier. Upon selection of an option (e.g., a menu item) from the function selection console 94, the execution element 72 may link to and/or launch a corresponding application associated with the option selected. In this regard, the function selection console 94 may execute a link to the corresponding application for execution of the application in connection with the predefined information stored in association with the particular identifier. For example, in response to selection of contact B, the function selection console 94 may be generated to include a call option, a send message option, a send email option, and an indication of presence information as shown in FIG. 5. As stated above, the options presented may be specific to the predefined information stored in association with contact B. In response to user selection of, for example, the send email option, the execution element 72 may launch an email application and automatically fill in the email address for contact B (and any other pertinent information which may be stored as predefined information) into an email message. The user may then compose the email message and send the email message according to normal procedures associated with the email application. Similar procedures to those described above with respect to email may also apply to calling, chat, SMS, MMS, push-to-talk, etc. functions.

As shown in FIGS. 4 and 5, the identifiers 90 may be presented in a list format. In FIGS. 4 and 5, the identifiers 90 are presented in a horizontal list. However, other formats for presentation of the identifiers 90 are also possible and, in an exemplary embodiment, may be selected using settings associated with the idle screen 80. Alternatively or additionally, the managing element 70 may be configured to receive user input regarding the presentation of the identifiers 90 and provide a corresponding output via the user interface element 76. Formats for presentation of the identifiers 90 may include a list format (which could be presented horizontally or vertically), a grid format, a wheel format, etc. Accordingly, the user may scroll through the identifiers 90 via a scroll function and select one of the identifiers 90. Selection of an identifier may be performed, for example, using a soft key or another function key of the mobile terminal 10. When a particular identifier is selected, as shown in FIG. 5, the selected identifier may be highlighted, for example, using a highlight window 92. Additionally, in response to selection of a particular identifier, the function selection console 94 may be presented to the user. In an exemplary embodiment, the function selection console 94 may be associated with the particular identifier as described above and may be presented in a shadow box, or via any other suitable mechanism.

The identifiers 90 may be a graphic, text, image, icon, etc. As shown in FIGS. 4 and 5, the identifiers 90 could each be an image associated with each corresponding contact. In this regard, the image could be accessed via any location accessible to the management element 70, or the image could be created, for example, using the camera module 36 as described above. Although, FIGS. 4 and 5 only show image related identifiers, it should be understood that any combination of different types of identifiers could be employed. Furthermore, in addition to controlling the presentation format of the identifiers 90, the management element 70 may also be configured to control attributes associated with the identifiers 90. For example, the management element 70 may be configured to control, responsive to user selection (e.g., user preferences accessed via the home screen settings), size, shape, color, resolution, language (for text entries), orientation, and/or the like, of the identifiers 90. Additionally, the management element 70 may be configured to enable the user to select a particular number of identifiers to be displayed at any given time.

In an exemplary embodiment, the identifiers 90 may be employed for only those contacts for which communication is most commonly conducted. For example, a majority of the communications that typical users engage in are conducted with in a relatively small number of contacts. Accordingly, rather than duplicating a user's contact list, the user may desire to create identifiers only for those contacts, individuals, entities, etc. with which communications are most commonly conducted. As a result, the identifiers, which each have predefined information associated with each corresponding contact, provide a single easily accessible location from which any type of communication that can be conducted with a particular contact can be arranged, thereby reducing the likelihood that a user may be required to utilize numerous different menus to conduct communications with a particular contact.

In an exemplary embodiment, the processing element 74 may be configured to track or otherwise receive indications of user activity with respect to various communication modes available to the mobile terminal 10. Accordingly, the processing element 74 may determine usage frequency information regarding which of the identifiers 90 are most frequently used or commonly utilized. The processing element 74 may be configured to order presentation of the identifiers 90 based on the usage frequency information. The processing element 74 may also be configured to reset a presentation of the identifiers 90 after each operation so that the most frequently used identifiers are always presented first and/or centered within the display by default. Alternatively, the processing element 74 may be configured to determine contact frequency information regarding which contacts are most frequently called, emailed, etc. and, in response to a determination that a particular contact is contacted, for example, above a threshold frequency or above a threshold percentage, the processing element 74 may prompt the user regarding creation of an identifier for the contact. In other words, if the processing element 74 determines that a particular contact is contacted at a frequency substantial enough to merit assignment of an identifier to the particular contact, the processing element 74 may provide a suggestion to the user with respect to creation of the identifier.

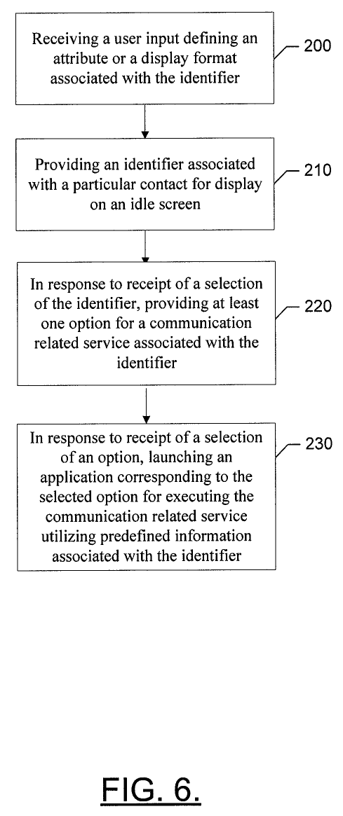

FIG. 6 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal and executed by a built-in processor in a mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing a visual link to contacts on the idle screen as illustrated in FIG. 6 may include providing an identifier associated with a particular contact for display on an idle screen at operation 210. Operation 210 could include providing one or more of an image, a graphic, an icon and text. In response to receipt of a selection of the identifier, at least one option for a communication related service associated with the identifier may be provided at operation 220. In an exemplary embodiment, the identifier could include a visual link to the at least one option as described below. Operation 220 could include providing only options corresponding to communication related services for which the predefined information includes information enabling connection with the particular contact according to an exemplary embodiment. In response to receipt of a selection of an option, an application corresponding to the selected option may be launched for executing the communication related service utilizing predefined information associated with the identifier at operation 230. The application could be, for example, an application associated with short message service (SMS), multimedia messaging service (MMS), email, chat, push-to-talk, presence, or calling. In an exemplary embodiment, an initial operation 200 of receiving a user input defining an attribute associated with the identifier and/or a display format associated with the identifier may be included.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
providing an identifier associated with a particular contact for display on an idle screen;
in response to receipt of a selection of the identifier, providing at least one option for a communication related service associated with the identifier; and
in response to receipt of a selection of an option, launching an application corresponding to the selected option for executing the communication related service utilizing predefined information associated with the identifier.

2. A method according to claim 1, wherein providing the identifier comprises providing one or more of an image, a graphic, an icon and text, and wherein the identifier comprises a visual link to the at least one option.

3. A method according to claim 1, further comprising receiving a user input defining an attribute associated with the identifier.

4. A method according to claim 1, further comprising receiving a user input defining a display format associated with the identifier.

5. A method according to claim 1, wherein providing the at least one option comprises providing only options corresponding to communication related services for which the predefined information includes information enabling connection with the particular contact.

6. A method according to claim 1, wherein launching the application comprises launching an application associated with one of short message service (SMS), multimedia messaging service (MMS), email, chat, push-to-talk, presence, or calling.

7. A method according to claim 1, further comprising issuing a prompt to a user enabling the user to create the identifier in response to a determination that communication with the particular contact is performed at a frequency above a threshold.

8. A method according to claim 1, wherein providing the identifier comprises providing a plurality of identifiers displayed in order of a frequency with which communications are conducted with each of the identifiers.

9. A computer program product comprising at least one computer-readable storage medium having computer-readable program code portions stored therein, the computer-readable program code portions comprising:
a first executable portion for providing an identifier associated with a particular contact for display on an idle screen;
a second executable portion for, in response to receipt of a selection of the identifier, providing at least one option for a communication related service associated with the identifier; and
a third executable portion for, in response to receipt of a selection of an option, launching an application corresponding to the selected option for executing the communication related service utilizing predefined information associated with the identifier.

10. A computer program product according to claim 9, wherein the first executable portion includes instructions for providing one or more of an image, a graphic, an icon and text, and wherein the identifier comprises a visual link to the at least one option.

11. A computer program product according to claim 9, further comprising a fourth executable portion for receiving a user input defining an attribute associated with the identifier.

12. A computer program product according to claim 9, further comprising a fourth executable portion for receiving a user input defining a display format associated with the identifier.

13. A computer program product according to claim 9, wherein the second executable portion includes instructions for providing only options corresponding to communication related services for which the predefined information includes information enabling connection with the particular contact.

14. A computer program product according to claim 9, wherein the third executable portion includes instructions for launching an application associated with one of short message service (SMS), multimedia messaging service (MMS), email, chat, push-to-talk, presence, or calling.

15. A computer program product according to claim 9, further comprising a fourth executable portion for issuing a prompt to a user enabling the user to create the identifier in response to a determination that communication with the particular contact is performed at a frequency above a threshold.

16. A computer program product according to claim 9, wherein the first executable portion includes instructions for providing a plurality of identifiers displayed in order of a frequency with which communications are conducted with each of the identifiers.

17. An apparatus comprising a processing element configured to:
provide an identifier associated with a particular contact for display on an idle screen;
in response to receipt of a selection of the identifier, provide at least one option for a communication related service associated with the identifier; and
in response to receipt of a selection of an option, launch an application corresponding to the selected option for executing the communication related service utilizing predefined information associated with the identifier.

18. An apparatus according to claim 17, wherein the identifier comprises one or more of an image, a graphic, an icon and text, and wherein the identifier comprises a visual link to the at least one option.

19. An apparatus according to claim 17, further comprising a user interface in communication with the processing element and configured to receive a user input defining an attribute associated with the identifier.

20. An apparatus according to claim 17, further comprising a user interface in communication with the processing element configured to receive a user input defining a display format associated with the identifier.

21. An apparatus according to claim 17, wherein the processing element is further configured to provide only options corresponding to communication related services for which the predefined information includes information enabling connection with the particular contact.

22. An apparatus according to claim 17, wherein the processing element is further configured to launch an application associated with one of short message service (SMS), multimedia messaging service (MMS), email, chat, push-to-talk, presence, or calling.

23. An apparatus according to claim 17, wherein the processing element is further configured to issue a prompt to a user enabling the user to create the identifier in response to a determination that communication with the particular contact is performed at a frequency above a threshold.

24. An apparatus according to claim 17, wherein the processing element is further configured to provide a plurality of identifiers displayed in order of a frequency with which communications are conducted with each of the identifiers.

25. An apparatus according to claim 17, wherein the apparatus is embodied as a mobile terminal.

26. An apparatus comprising:
means for providing an identifier associated with a particular contact for display on an idle screen;
means for, in response to receipt of a selection of the identifier, providing at least one option for a communication related service associated with the identifier; and
means for, in response to receipt of a selection of an option, launching an application corresponding to the selected option for executing the communication related service utilizing predefined information associated with the identifier.

27. An apparatus according to claim 26, further comprising means for receiving a user input defining an attribute associated with the identifier.

28. An apparatus according to claim 26, further comprising means for receiving a user input defining a display format associated with the identifier.
